(19) United States
(12) Patent Application Publication
(10) Pub. No.: US 2025/0181281 A1
(43) Pub. Date: Jun. 5, 2025

(54) CONTROL METHOD AND INFORMATION PROCESSING APPARATUS

(71) Applicant: CANON KABUSHIKI KAISHA, Tokyo (JP)

(72) Inventor: Keiji Kawasaki, Kanagawa (JP)

(21) Appl. No.: 19/049,874

(22) Filed: Feb. 10, 2025

Related U.S. Application Data
(63) Continuation of application No. 17/849,427, filed on Jun. 24, 2022.
Application No. 17/849,427 is a continuation of application No. PCT/JP2020/047007, filed on Dec. 16, 2020.

(30) Foreign Application Priority Data
Dec. 27, 2019 (JP) 2019-239037

(51) Int. Cl. G06F 3/12

(52) U.S. Cl. CPC G06F 3/1205; G06F 3/1225; G06F 3/1276

(57) ABSTRACT

A control method of an information processing apparatus on which an extension application for extending a function unsupported by print data generation software configured to generate print data is operable, includes adding information regarding a first function being a function unsupported by the print data generation software, designating information regarding a second function being a function supported by the print data generation software in a case where the first function is designated, and generating print data for implementing the first function based on the designated information regarding the second function.

### CROSS-REFERENCE TO RELATED APPLICATIONS

This application is a Continuation of U.S. patent application Ser. No. 17/849,427, filed Jun. 24, 2022, which is a Continuation of International Patent Application No. PCT/JP2020/047007, filed Dec. 16, 2020, which claims the benefit of Japanese Patent Application No. 2019-239037, filed Dec. 27, 2019, all of which are hereby incorporated by reference herein in their entirety.

### BACKGROUND OF THE INVENTION

### Field of the Invention

The present invention relates to a control method and an information processing apparatus. The present invention relates particularly to a technique of an extension application.

### Background Art

There has been known a configuration of issuing a printing instruction to a printing apparatus connected to a host computer, using a printer driver installed on the host computer as control software of the printing apparatus. An operating system (OS) being basic software is installed on the host computer. The printer driver is configured in accordance with the specification defined by the OS, and operates by being invoked from the OS. By providing the printer driver conforming to the specification defined by the OS, a vendor providing the printing apparatus can provide a unit configured to issue a printing instruction to the printing apparatus using the OS.

In recent years, a standard class driver (hereinafter, will also be referred to as a standard driver) that can be used in common by printing apparatuses provided by a plurality of vendors is provided in the Windows (registered trademark). Such a standard driver is enclosed in the package of an OS and enables any printing apparatus to be easily used by connecting the printing apparatus to a host computer. Thus, there is no need to separately install a model-specific printer driver suitable for the printing apparatus. This enhances the convenience. In addition, the standard driver is configured to be capable of designating a print function based on PrintCapabilities generated based on information acquired from the connected printing apparatus. With this configuration, a user using the standard driver can designate print functions suitable for capabilities of connected printing apparatuses although the user uses one standard driver.

An application for function extension (hereinafter, will also be referred to as an extension application) can be associated with the standard driver. A vendor providing the printing apparatus can provide the extension application. By providing the extension application, the vendor can provide a function (extended function) that cannot be implemented just by the standard driver. Japanese Patent Application Laid-Open No. 2019-74906 discusses a technique of extending a function such as a stamp function using an extension application.

### CITATION LIST

### Patent Literature

PTL 1: Japanese Patent Application Laid-Open No. 2019-74906

### SUMMARY OF THE INVENTION

According to an aspect of the present invention, a control method of an information processing apparatus on which an extension application for extending a function unsupported by print data generation software configured to generate print data is operable, includes adding information regarding a first function being a function unsupported by the print data generation software, designating information regarding a second function being a function supported by the print data generation software in a case where the first function is designated, and generating print data for implementing the first function based on the designated information regarding the second function.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration of a printing system.

FIG. 2A is a block configuration diagram of the printing system.

FIG. 2B is a block configuration diagram of the printing system.

FIG. 3 is a flowchart illustrating print function information editing processing to be executed by a print function extension unit.

FIG. 4A illustrates an example of Print Device Capabilities (PDC).

FIG. 4B illustrates an example of PDC.

FIG. 5 illustrates an example of an added function list.

FIG. 6A illustrates an example of PrintTicket.

FIG. 6B illustrates an example of PrintTicket.

FIG. 7A illustrates a layout editing example obtained by an N-Up function.

FIG. 7B illustrates a layout editing example obtained by the N-Up function.

FIG. 8 is a flowchart illustrating print setting change processing to be executed by a print setting editing unit.

FIG. 9 illustrates an example of a setting change list.

FIG. 10 is a flowchart illustrating print data editing processing to be executed by a print data editing unit.

FIG. 11 illustrates an example of print setting attribute information.

FIG. 12 illustrates a screen example of a print setting screen extension unit.

FIG. 13 is a flowchart illustrating print function information editing processing to be executed by a print function extension unit.

FIG. 14 is a flowchart illustrating print setting change processing to be executed by a print setting editing unit.

FIG. 15A illustrates a layout editing example obtained by a booklet function.

FIG. 15B illustrates a layout editing example obtained by the booklet function.

FIG. 16 is a flowchart illustrating print setting change processing to be executed by a print setting editing unit.

FIG. 17 is a flowchart illustrating print data editing processing to be executed by a print data editing unit.

### DESCRIPTION OF THE EMBODIMENTS

The extension application discussed in Japanese Patent Application Laid-Open No. 2019-74906 can edit a spool file. By editing the spool file, the extension application can implement an N-Up print function. Nevertheless, for the extension application that extends a function of a standard driver to provide a better function, further contrivance is required.

Exemplary embodiments of the present invention will be described in detail below with reference to the attached drawings. The following exemplary embodiments are not intended to limit the present invention set forth in the appended claims. In addition, not all the combinations of features described in the exemplary embodiments are essential to the solution of the present invention. The same components are assigned the same reference numerals, and a redundant description will be omitted.

### First Exemplary Embodiment

### Hardware Configuration of Printing System

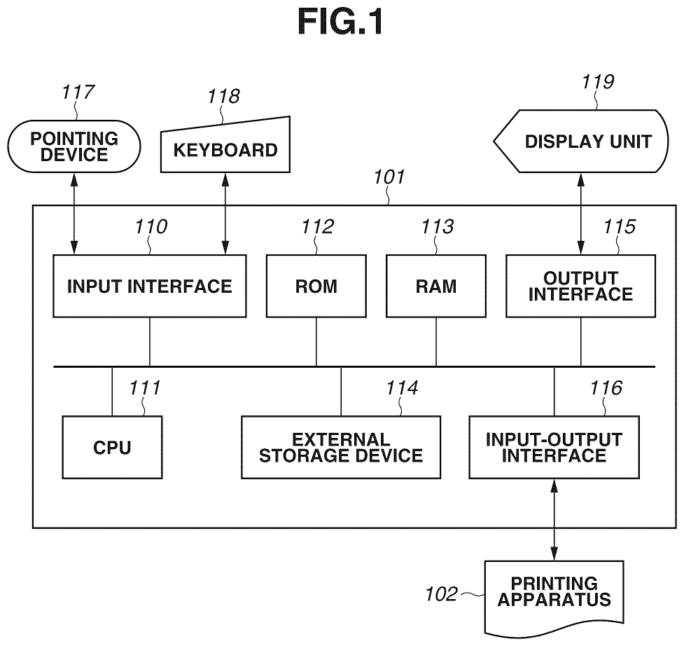

FIG. 1 is a block diagram illustrating a hardware configuration of a printing system. In FIG. 1, a host computer 101 is an example of an information processing apparatus, and includes an input interface 110, a central processing unit (CPU) 111, a read-only memory (ROM) 112, a random access memory (RAM) 113, an external storage device 114, an output interface 115, and an input-output interface 116. In addition, input devices such as a keyboard 118 and a pointing device 117 are connected to the input interface 110, and a display device such as a display unit 119 is connected to the output interface 115.

The ROM 112 stores an initialization program. The external storage device 114 stores application programs, an operating system (OS), print data generation software, and other various types of data. The RAM 113 is used as a work memory in executing various programs stored in the external storage device 114. The various programs can operate in the host computer 101.

In the present exemplary embodiment, by performing processing in accordance with a procedure of a program stored in the ROM 112, the CPU 111 executes a function in the host computer 101, which will be described below, and processing illustrated in a flowchart, which will be described below. A printing apparatus 102 being a device is connected with the host computer 101 via the input-output interface 116. In this example, the host computer 101 and the printing apparatus 102 are separately formed; however, the host computer 101 and the printing apparatus 102 may be formed as one information processing apparatus. As an example of the printing apparatus 102, an inkjet printer that executes printing by discharging ink onto a sheet surface will be described, but printing may be executed using another method (e.g., electrophotographic method). In addition, the host computer 101 may be a desktop personal computer, a smartphone, or a laptop personal computer.

### Configuration of Printing System

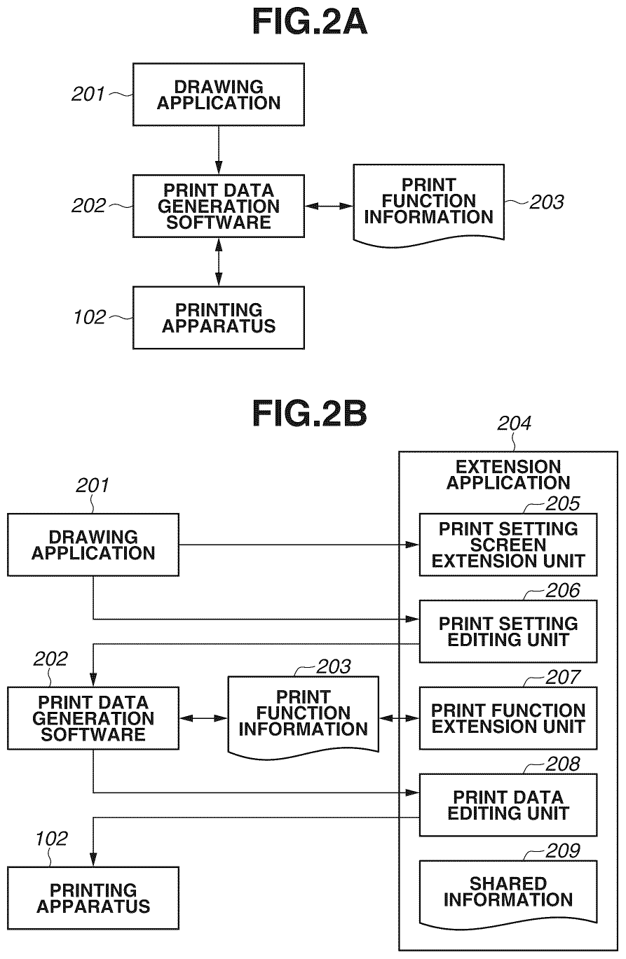

FIGS. 2A and 2B are diagrams schematically illustrating a configuration of the printing system. The description will be given on the premise that the printing system includes the host computer 101 installed with Windows (registered trademark) 10 of Microsoft (registered trademark) as an OS. FIG. 2A is a diagram illustrating a general configuration employed in a case where an extension application 204 is not associated with print data generation software 202 and the printing apparatus 102.

A drawing application 201 is software that creates content (drawing data) to be printed. For example, a document creation application or a spreadsheet application corresponds to the drawing application 201. If the drawing application 201 receives a print request from the user, the drawing application 201 issues a printing instruction to the OS. The printing instruction includes print setting information for designating operations of the print data generation software 202 and the printing apparatus 102. The print setting information will also be referred to as PrintTicket (hereinafter, PT).

To output the print setting information, the drawing application 201 can display a print setting screen provided by any one of the print data generation software 202, the OS, or the drawing application 201. In accordance with capability information acquired from the print data generation software 202 (information settable as a print setting), the print setting screen includes a setting item (hereinafter, will also be referred to as a control item) indicating a settable print function, and a control item indicating a setting value thereof. The capability information will also be referred to as PrintCapabilities (hereinafter, PC). The print data generation software 202 determines PC based on print function information 203. The print function information 203 is data indicating print functions. All settable print functions, setting values thereof, and an exclusive relationship between the setting values are described in the print function information 203. The print function information 203 will also be referred to as Print Device Capabilities (PDC). The print function information 203 is included in a configuration file of the print data generation software 202 and stored in the external storage device 114 as an unchangeable file. Alternatively, the print function information 203 can also be dynamically generated by the print data generation software 202. Specifically, the print data generation software 202 or the OS can be configured to acquire printing apparatus attribute data from the printing apparatus 102, and generate the print function information 203 based on attribute information included in the acquired attribute data. In a case where the print function information 203 is dynamically generated, the generated print function information 203 is editable. The printing apparatus attribute data to be acquired from the printing apparatus 102 is a response to be acquired by issuing a Get-Printer-Attributes operation of an Internet Print Protocol (IPP) to the printing apparatus 102. The response includes attribute information indicating functions that can be designated in the printing apparatus 102 (capabilities of the printing apparatus 102), and setting values related to the attribute information. The response is stored in the RAM 113.

With such a configuration, the print data generation software 202 can be configured to enable the user to designate a print function usable on each printing apparatus 102 depending on a connected printing apparatus 102. More specifically, even in a case where a printing apparatus having a different function or a printing apparatus developed by a different vendor is connected, the print data generation software 202 can be configured to enable the user to designate a usable print function depending on the connected printing apparatus. The description will be given of a configuration in which an IPP Class Driver installed on Windows (registered trademark) 10 is used as the print data generation software 202. The IPP Class Driver is a printer driver that executes print processing in accordance with a specification of a standard print protocol called IPP and is enclosed in the package of the OS. The IPP Class Driver is not a printer driver specific to the model of the printing apparatus 102, but a standard class driver that can be used in common by a plurality of printing apparatuses. The IPP Class Driver acquires capability information on a connected printing apparatus 102 and generates the print function information 203 based on the acquired capability information in such a manner that the user can designate a print function supported by the connected printing apparatus 102.

The OS generates intermediate data (will also be referred to as input data) based on a printing instruction output from the drawing application 201, and delivers the generated intermediate data to the print data generation software 202. The data to be output by the drawing application 201 for printing is data in a Graphic Device Interface (GDI) format (GDI-format data) or data in an Extensible Markup Language (XML) Paper Specification format (XPS-format data). In a case where the IPP Class Driver is used as the print data generation software 202, if data output by the drawing application 201 is GDI-format data, the OS converts the GDI-format data output from the drawing application 201 into XPS-format data. Then, the OS delivers the converted XPS-format data to the print data generation software 202 as the intermediate data. If data output by the drawing application 201 is XPS-format data, the OS delivers the XPS-format data to the print data generation software 202 as the intermediate data. The intermediate data includes drawing data being information regarding a picture to be formed on a sheet surface, and print setting information set by the user.

The print data generation software 202 converts the acquired intermediate data into print data interpretable by the printing apparatus 102, and transmits the converted print data to the printing apparatus 102. The print data includes drawing data being information regarding a picture to be formed on a sheet surface, and print setting attribute information (attribute information designating a print setting) generated based on the print setting information set by the user. The print setting attribute information includes attribute information indicating functions that can be designated in the printing apparatus 102 (capabilities of the printing apparatus 102), and setting values related to the attribute information.

The printing apparatus 102 performs printing on a sheet surface based on the print data transmitted from the print data generation software 202. At this time, the printing apparatus 102 forms drawing data included in the print data on the sheet surface by an operation based on the print setting attribute information included in the print data. The print setting attribute information includes print quality (image quality priority, speed priority, etc.), attribute information for designating duplex printing, and a setting value thereof. For example, in a case where the print setting attribute information includes the attribute information that designates duplex printing, the printing apparatus 102 executes the duplex printing.

FIG. 2B is a diagram illustrating a configuration employed in a case where the extension application 204 is associated with the print data generation software 202 and the printing apparatus 102. The components and processing not specifically mentioned below are equivalent to those illustrated in FIG. 2A.

The extension application 204 is software for extending a function of the print data generation software 202, and is software not preliminarily included in (not supplied with) an OS. Thus, the user downloads the extension application 204 from a server via the Internet by operating the host computer 101, and installs the downloaded extension application 204. Alternatively, the extension application 204 may be automatically installed based on the printing apparatus 102 being connected to the host computer 101. Specifically, in a case where the printing apparatus 102 is connected to the host computer 101, the OS acquires device identification information from the printing apparatus 102. The OS may download the extension application 204 corresponding to the acquired device identification information from a server via the Internet, and install the downloaded extension application 204. In other words, the print data generation software 202 and the extension application 204 are stored in the host computer 101 as different files.

The print data generation software 202 and the extension application 204 are sometimes updated and upgraded. Update processing is performed thereon at different timings. More specifically, a timing at which the print data generation software 202 is acquired by the host computer 101 and a timing at which the extension application 204 is acquired by the host computer 101 are different. In addition, a trigger by which the print data generation software 202 is acquired by the host computer 101 and a trigger by which the extension application 204 is acquired by the host computer 101 are different as well. In a case where the extension application 204 is installed, the OS associates the installed extension application 204 with the print data generation software 202 and the printing apparatus 102.

The extension application 204 described in the present exemplary embodiment includes a print setting screen extension unit 205, a print setting editing unit 206, a print function extension unit 207, and a print data editing unit 208. The extension application 204 also includes shared information 209 accessible in common by each unit. In actuality, the shared information 209 is a file stored in the external storage device 114 or information stored on the RAM 113. By using an application program interface (API) provided by the OS, the extension application 204 writes information to and reads information from the shared information 209.

The extension application 204 may end an operation each time processing of each unit ends. In this case, each time a usage request of each unit is received, the OS activates the extension application 204. In another configuration, for example, while the OS ends the operation of the extension application 204 upon an end of processing of the print setting screen extension unit 205, the OS may leave the extension application 204 in an activated state even if processing of the print setting editing unit 206 ends.

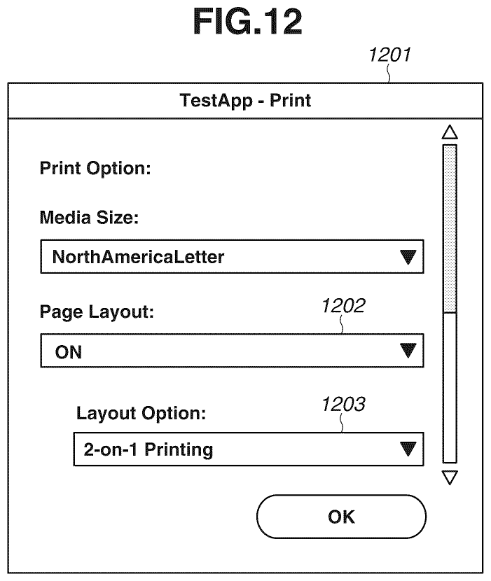

If the drawing application 201 receives a print request from the user, the drawing application 201 issues a printing instruction to the OS. Also in this configuration, the drawing application 201 can display a print setting screen as in the configuration illustrated in FIG. 2A. In this configuration, a print setting screen provided by the extension application 204 is displayed. Specifically, a print setting screen provided by the print setting screen extension unit 205 included in the extension application 204 is displayed. Whether the print setting screen provided by the print setting screen extension unit 205 is displayed depends on an operation of the user. The details of the print setting screen extension unit 205 will be described below with reference to FIG. 12.

The OS generates intermediate data based on the printing instruction output from the drawing application 201, and delivers the generated intermediate data to the print setting editing unit 206. The print setting editing unit 206 edits print setting information (PT) included in the generated intermediate data, and delivers the edited print setting information to the OS. The print setting editing unit 206 can display a screen on the display unit 119, or can avoid displaying a screen. Irrespective of an operation of the user, the print setting editing unit 206 can determine whether to display a screen provided by the print setting editing unit 206 on the display unit 119. Thus, desirably, the print setting editing unit 206 is configured such that a setting or a function that needs always to be designated by the user for each print job can be designated on the screen displayed by the print setting editing unit 206. Examples of such a function include SecurePrint that uses a personal identification number (PIN), and information regarding a destination for fax transmission (transmission destination, fax number, etc.). In this example, the print setting editing unit 206 stores PIN information designated by the user in print setting information, and delivers the print setting information to the OS. The PIN information designated by the user may be stored in the shared information 209 accessible in common by each unit.

The OS delivers intermediate data including the edited print setting information to the print data generation software 202. The print data generation software 202 converts the intermediate data into print data interpretable by the printing apparatus 102. The OS delivers the converted print data to the print data editing unit 208. The OS may be configured to further deliver the print setting information included in the intermediate data to the print data editing unit 208.

The print data editing unit 208 edits the print data generated by the print data generation software 202, and delivers the edited print data to the OS. For example, in the case of SecurePrint, the print data editing unit 208 reads the PIN information designated using the print setting editing unit 206 from the print setting information received from the OS, or the shared information 209, and adds the read PIN information to the print setting attribute information included in the print data.

The OS transmits the print data edited by the print data editing unit 208 to the printing apparatus 102. The printing apparatus 102 performs printing on a sheet surface based on the print data transmitted from the print data generation software 202.

The extension application 204 also includes the print function extension unit 207. The print function extension unit 207 can edit the print function information 203 (PDC) generated by the print data generation software 202 or the OS. The print function extension unit 207 can thereby add a function provided by the extension application 204, add a function that is supported by the printing apparatus 102 but unsupported by the print data generation software 202, and add an exclusive relationship between setting values of print functions. When the extension application 204 is associated with the printing apparatus 102 and the print data generation software 202 for the first time, the OS activates the print function extension unit 207. Furthermore, the OS may activate the print function extension unit 207 at other timings such as the time of OS activation. With this configuration, in a case where an optional device (e.g., finisher) is added to the printing apparatus 102 afterward and a function related to printing is extended, the print function extension unit 207 can detect the extended function and add the extended function to the print function information 203.

The configuration of the extension application 204 for implementing the present exemplary embodiment is not limited to the configuration including all of the above-described functions (units), and may be a configuration including only part of the functions or including another function. The extension application 204 will be sometimes referred to simply as printing software. As described above, the extension application 204 can be said to include at least one of a function of displaying a setting screen (the print setting screen extension unit 205), a function of editing intermediate data input to the print data generation software 202 (the print setting editing unit 206), a function of editing print data input to the printing apparatus 102 (the print data editing unit 208), and a function of extending a function that can be designated in the print data generation software 202 (the print function extension unit 207).

### Print Function Information Editing Processing to Be Executed by Print Function Extension Unit

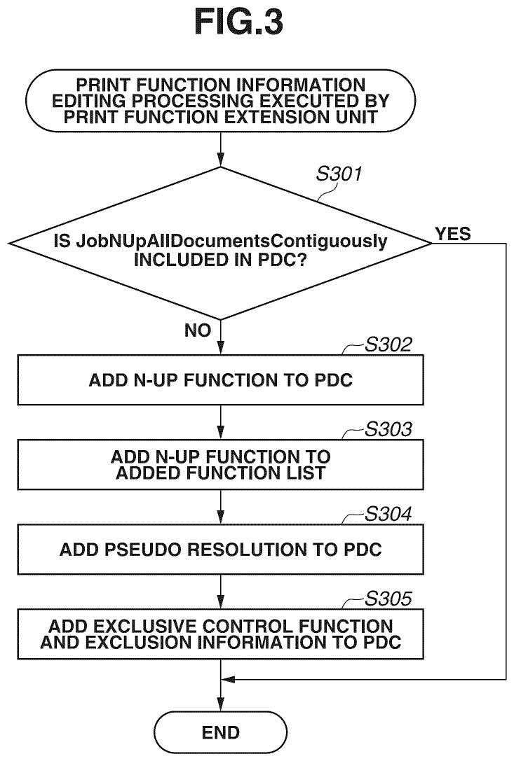

FIG. 3 is a diagram illustrating a major processing procedure of print function information editing processing to be executed by the print function extension unit 207 in the printing system. In the following description, each piece of processing will be described as being executed by the print function extension unit 207 in some cases. Actually, a corresponding function is implemented by the CPU 111 executing a corresponding program.

First, the procedure illustrated in FIG. 3 is started by the OS activating the print function extension unit 207 at a timing at which the extension application 204 is associated for the first time.

In step S301, the print function extension unit 207 determines whether PDC include a Feature JobNUpAllDocumentsContiguously.

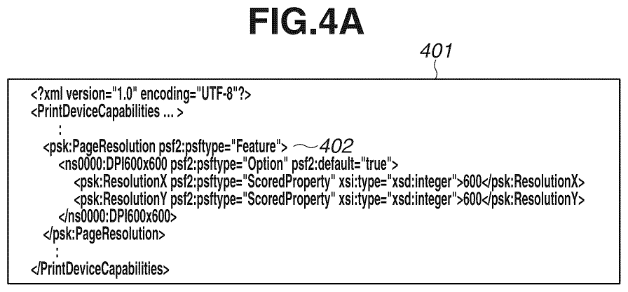

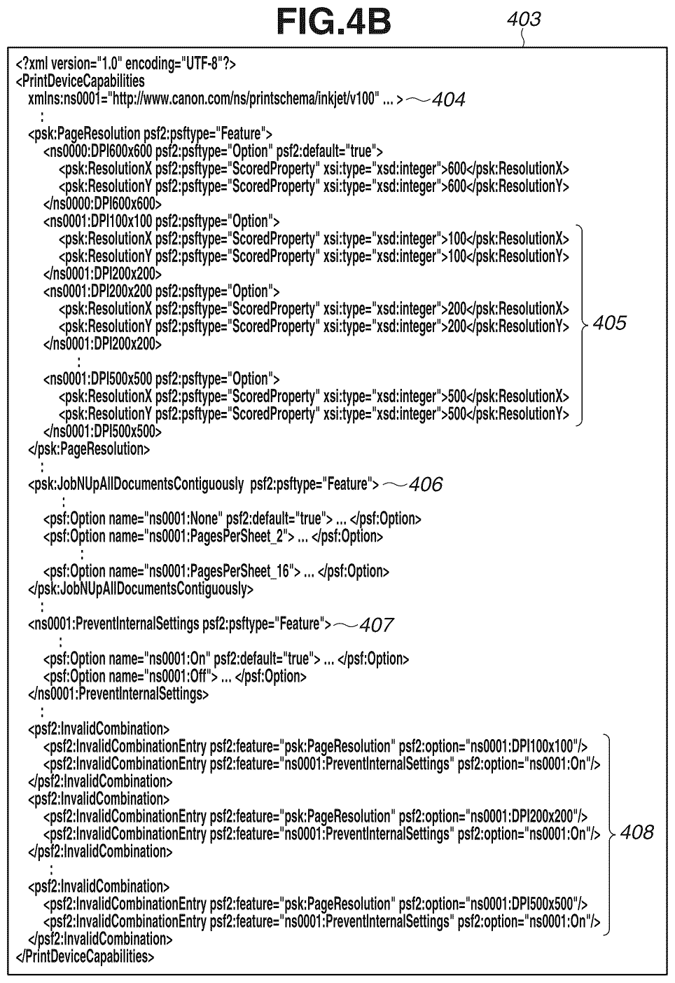

An example of PDC will be described with reference to FIG. 4A. PDC 401 include information regarding a function (Feature) supported by the printing apparatus 102, information regarding a setting value (Option) of a certain function, and exclusive information indicating that specific functions cannot be simultaneously selected. For example, information 402 indicates that 600×600 dots per inch (dpi) can be designated as PageResolution (resolution). In a case where determination in step S301 is YES (YES in step S301), the print function extension unit 207 ends the processing of this procedure. In this example, because the PDC 401 do not include JobNUpAllDocumentsContiguously, the determination in step S301 is NO. In a case where step S301 is determined as NO (NO in step S301), the processing proceeds to step S302.

In step S302, the print function extension unit 207 adds an N-Up function to the PDC. FIG. 4B illustrates an example of PDC edited in this flowchart. In this example, the N-Up function is added to PDC 403 as a Feature name

JobNUpAllDocumentsContiguously as indicated by information 406. In addition, Options such as None and PagePerSheet_2 are supported as settable values of the function. The Feature name and the Options are merely examples, and another name (information indicating the function) or another settable value may be used.

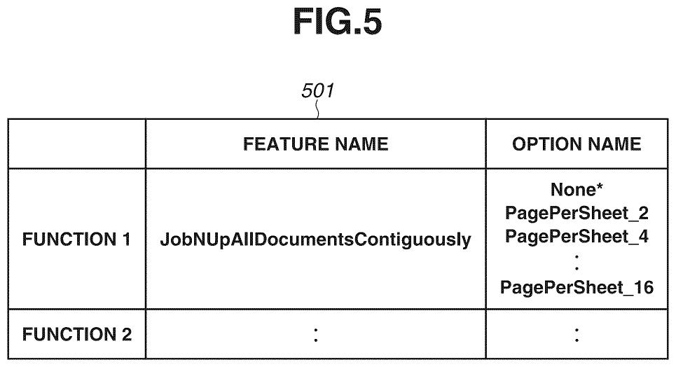

In step S303, the print function extension unit 207 adds the N-Up function to an added function list, and stores the added function list in the shared information 209. FIG. 5 illustrates an example of the added function list. An added function list 501 stores a Feature name of the function added to the PDC in the processing in step S302, and a list of Options that can be designated in association. Information indicating an Option being a default designated value among Options is also included. In this example, because an asterisk (*) is added to an Option None, it is indicated that the Option None is a default designated value. In this flowchart, the print function extension unit 207 adds only the N-Up print function, but the print function extension unit 207 may be configured to add two or more functions. Thus, an added function list has a configuration in which two or more pieces of function information can be stored.

In step S304, the print function extension unit 207 adds a pseudo resolution to the PDC. The pseudo resolution is resolution that is unsupported by the printing apparatus 102 but supported by the print data generation software 202 or the extension application 204, and is a false resolution to be used in the extension application 204.

An example of pseudo resolution information to be added to PDC will be described with reference to the PDC 403 illustrated in FIG. 4B, again. In the PDC 401 before pseudo resolutions are added, 600×600 dpi is designated as the resolution. After the adding processing executed in step S304, Options (information 405) corresponding to 100×100 dpi, 200×200 dpi, 300×300 dpi, 400×400 dpi, and 500×500 dpi are further added.

In other words, five Options in increments of 100 dpi are newly added. A larger number of Options in finer increments may be added, or a required pseudo resolution obtained by calculation to be described below may be added. The print function extension unit 207 further adds information 404 regarding a name space of an added Option, to the PDC.

Lastly, in step S305, the print function extension unit 207 adds an exclusive control function and exclusive information to the PDC. Information to be added to the PDC will be described with reference to the PDC 403 illustrated in FIG. 4B, again. First, information 407 is added to the PDC 403 as the exclusive control function. A Feature PreventInternalSettings and two Options corresponding to On and Off serving as setting values thereof are added as the information 407. Next, information 408 is added as the exclusive information. The information 408 indicates that each Option of a pseudo resolution (the information 405) added to the PageResolution function and the On Option of the PreventInternalSettings function are in an exclusive relationship, and cannot be simultaneously set. With this configuration, to use a pseudo resolution, the Off Option of the PreventInternalSettings function is to be explicitly designated, and it is possible to prevent the user or high-order software from erroneously designating the pseudo resolution. In other words, the exclusive information for exclusive control is prevention information for preventing a pseudo resolution from being designated.

By the above-described processing, as information regarding the N-Up function, each Option of a pseudo resolution and the exclusive control function are added to PrintCapabilities (PC) being capability information that are generated based on PDC being the print function information 203.

### Example of Screen to Be Displayed by Print Setting Screen Extension Unit

Next, a print setting screen to be displayed based on the generated PC will be described with reference to FIG. 12. A print setting screen 1201 illustrated in FIG. 12 is an example of a screen to be displayed by the print setting screen extension unit 205 based on PC generated by the above-described processing. The print setting screen extension unit 205 is invoked from the OS in a case where the user issues a display instruction of a print setting screen on the drawing application 201. The print setting screen extension unit 205 displays a screen on which the user can designate a print function that can be designated in the print data generation software 202, based on PC that can be acquired from the OS.

Based on the Feature JobNUpAllDocumentsContiguously that has been added to the PC, the print setting screen extension unit 205 displays a control item 1202 for switching between an enabled state and a disabled state of the N-Up function. The print setting screen extension unit 205 also displays a control item 1203 selectable as the number of pages per sheet, based on each Option of JobNUpAllDocumentsContiguously in the PC. With this configuration, the user can designate the N-Up function added by the print function extension unit 207. An Option indicating a pseudo resolution in the resolution function added by the print function extension unit 207, and the exclusive control function are to be internally used by the extension application 204. Thus, it is desirable that the Option and the exclusive control function be not included in the print setting screen to prevent the user from designating the Option and the exclusive control function.

### Processing Procedure of Print Setting Editing Unit

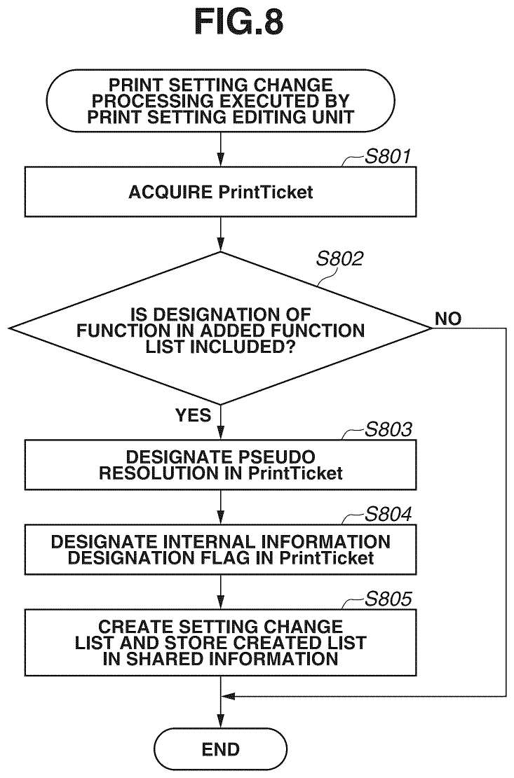

FIG. 8 is a diagram illustrating a major processing procedure of print setting change processing to be executed by the print setting editing unit 206 in the printing system. In the following description, each piece of processing will be described as being executed by the print setting editing unit 206 in some cases. Actually, a corresponding function is implemented by the CPU 111 executing a corresponding program.

The processing illustrated in FIG. 8 is started by the OS generating intermediate data based on a printing instruction output from the drawing application 201, and activating the print setting editing unit 206. The print setting editing unit 206 according to the present exemplary embodiment does not display a screen on the display unit 119.

In step S801, the print setting editing unit 206 acquires a PT being print setting information included in the intermediate data.

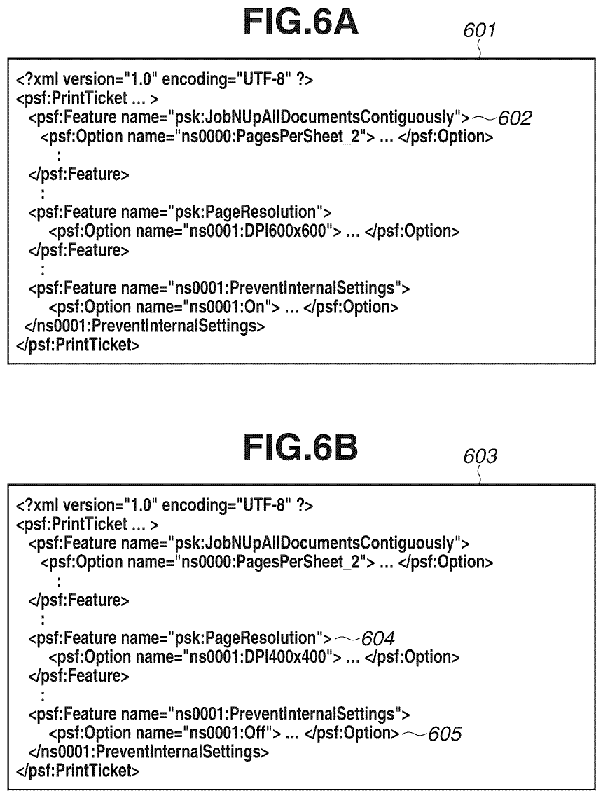

In step S802, the print setting editing unit 206 determines whether the PT includes designation of a function included in the added function list. An example of the PT will be described with reference to FIG. 6A. In a PT 601, an Option PagesPerSheet_2 of the JobNUpAllDocumentsContiguously function is designated as indicated by information 602. The function is a function existing in the added function list 501, and the Option is an Option different from the None Option being a default Option. In this example, the N-Up function with the number of pages per sheet being two for printing drawing data corresponding to two pages on one sheet (will also be referred to as 2-Up, 2-in-1, or 2-on-1) is designated by the user on the print setting screen 1201 illustrated in FIG.

12. Thus, in the PT 601, the Option PagesPerSheet_2 corresponding to the setting value of the N-Up function is designated. In such a case, the print setting editing unit 206 determines that step S802 is YES (YES in step S802), and the processing proceeds to step S803. In a case where the print setting editing unit 206 determines that step S802 is NO (NO in step S802), the processing of this flowchart is ended.

In step S803, the print setting editing unit 206 designates a pseudo resolution in the PT. FIG. 6B illustrates an example of the PT changed by the print setting editing unit 206. In this example, by the processing to be described below, a pseudo resolution DPI 400×400 is designated in PageResolution, which is a function indicating a resolution, as indicated by information 604 in a PT 603.

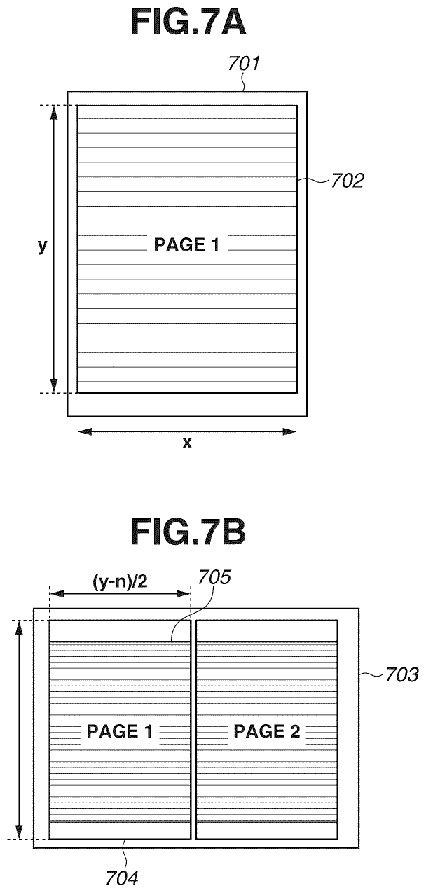

A designation method of the pseudo resolution will be described with reference to FIGS. 7A and 7B. FIG. 7A is a schematic diagram illustrating drawing data corresponding to one page among pieces of drawing data included in intermediate data. In each piece of page information included in the drawing data, a printable region 702 exists in a sheet size 701, and drawing data generated by the drawing application 201 for printing is included in the printable region 702. In this example, a width and a height of the printable region 702 are denoted by x and y, respectively.

FIG. 7B illustrates an example of an output result of the printing apparatus 102 that is obtainable when the drawing data as illustrated in FIG. 7A corresponding to two pages is printed while the N-Up function with the number of pages per sheet being two is designated. Images corresponding to two pages that are based on the drawing data are printed side by side within a printable region in a sheet size 703. A width of a region 704 in which Page 1 can be arranged is denoted by (y−n)/2, and a height thereof is denoted by x, where n denotes a width of a blank region provided between Page 1 and Page 2. An aspect ratio of the region 704 does not always coincide with an aspect ratio of the printable region 702 of the original drawing data. In a case where the aspect ratios do not coincide with each other, the printable region 702 is arranged to be inscribed in the region 704 so that drawing information included in the printable region 702 does not become deficient.

For example, in a case where a sheet size is A4, the width x of the printable region 702 excluding margins is 203.2 (mm), and the height y is 287 (mm), if the width n is set to 5 (mm), the width of the region 704 becomes (287−5)/2=141 (mm), and the height of the region 704 becomes 203.2 (mm) because the height is equal to the width x. Reduction ratios in a width direction and a height direction that are required for arranging the printable region 702 in the region 704 are calculated as follows.
Width direction: 141/203.2=0.694
Height direction: 203.2/287=0.708

In the designation in the PT 601, the designation of a resolution is 600 dpi. At this time, expected values of pseudo resolutions in the width direction and the height direction are calculated as follows.
Width direction: 0.694×600=416.4 (dpi)
Height direction: 0.708×600=424.8 (dpi)

As described above, to obtain a result in which the printable region 702 is inscribed in the region 704, in this example, the smaller value of two pseudo resolutions, namely, 416.4, is employed. When a size of print data obtained by the print data generation software 202 converting intermediate data at 600 dpi is the size of the printable region 702 illustrated in FIG. 7A, if the same intermediate data is converted at 416.4 dpi, the size of the print data becomes a size 705 illustrated in FIG. 7B. In the PDC 403 according to the present exemplary embodiment, the function is extended in such a manner that five pseudo resolutions in increments of 100 dpi can be designated, and a pseudo resolution 416.4 dpi cannot be designated. Thus, in the processing in step S804, the print setting editing unit 206 designates a pseudo resolution that is the closest to 416.4 and is as large as possible. In the above-described example, the print setting editing unit 206 designates the DPI 400×400 Option indicating 400 dpi, in the PT. As described above, in the processing in step S305, the print function extension unit 207 may preliminarily calculate a pseudo resolution to be required, which is the resolution 416 dpi in this example, and register the pseudo resolution. Nevertheless, if the types of resolution to be added are too many, processing speed might decrease. Thus, it is desirable to limit the resolutions to be add to representative ones to some extent.

Next, in step S804, the print setting editing unit 206 designates the Feature PreventInternalSettings and a setting value Off in the PT. Information 605 in the PT 603 is an example of information to be added by the processing. More specifically, the information 408 defines an exclusive relationship that prevents each Option of the pseudo resolution from being designated in a case where the PreventInternalSettings is set to On. By the definition, in a case where the PreventInternalSettings is set to On, the pseudo resolution may be regarded as an invalid value, and may be sometimes changed by the print data generation software 202 to another resolution. Thus, in step S804, to prevent this, the print setting editing unit 206 accordingly performs processing of changing the setting value to a setting value indicating that the pseudo resolution can be designated.

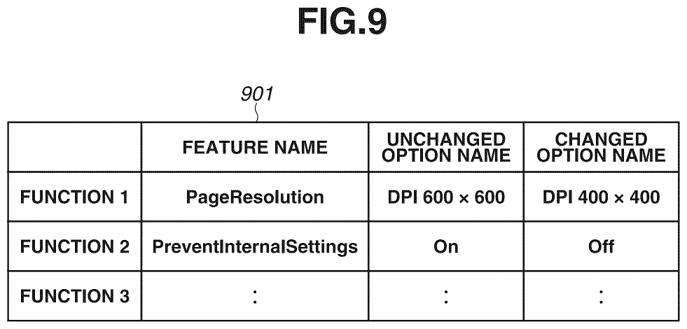

Lastly, in step S805, the print setting editing unit 206 creates a setting change list and stores the created setting change list in the shared information 209. FIG. 9 illustrates an example of the setting change list to be stored in the shared information 209. A setting change list 901 includes information regarding a change made by the print setting editing unit 206 on the PT. An example of information to be stored in the setting change list will be described below with reference to the above-described example. As a first piece of information, information indicating that an Option of the Feature PageResolution has been changed from DPI 600×600 to DPI 400×400 is stored. The information is information reflecting a result of the processing executed by the print setting editing unit 206 in step S803. As a second piece of information, information indicating that an Option of the Feature PreventInternalSettings has been changed from On to Off is stored. The information is information reflecting a result of the processing executed by the print setting editing unit 206 in step S804.

As described above, the print setting editing unit 206 according to the present exemplary embodiment edits a PT included in intermediate data in a case where a specific function is designated. The print data generation software 202, which performs processing subsequent to the processing of the print setting editing unit 206, generates print data based on the intermediate data including the edited PT. In the above-described example, since the resolution has been changed from 600 dpi to 400 dpi, the drawing data included in the print data generated by the print data generation software 202 becomes drawing data reduced to a ⅔ of the original size in both longitudinal and traverse directions. The size is a size falling within the region 704 illustrated in FIG. 7B. The print data editing unit 208 to be described below can convert the drawing data into drawing data for expected N-Up printing only by moving the drawing data to an appropriate location without enlarging or reducing (changing the size of) the drawing data.

### Processing Procedure of Print Data Editing Unit

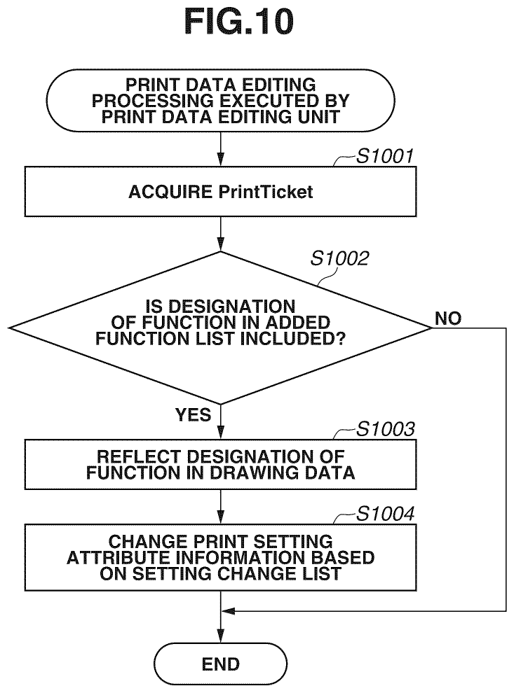

FIG. 10 is a diagram illustrating a major processing procedure of print data editing processing to be executed by the print data editing unit 208 in the printing system. In the following description, each piece of processing will be described as being executed by the print data editing unit 208 in some cases. Actually, a corresponding function is implemented by the CPU 111 executing a corresponding program.

The processing illustrated in FIG. 10 is started by the OS delivering print data converted by the print data generation software 202 from intermediate data to the print data editing unit 208.

In step S1001, the print data editing unit 208 acquires a PT. The PT to be acquired in this step is the PT edited by the print setting editing unit 206 in the processing in steps S803 and S804. The print data editing unit 208 may acquire the PT using an API of the OS, or may acquire the PT stored by the print setting editing unit 206 in the shared information 209.

Next, in step S1002, the print data editing unit 208 determines whether the PT includes designation of a function included in the added function list. In a case where the print data editing unit 208 determines that step S1002 is NO (NO in step S1002), the processing of the flowchart is ended. The description will be given of an example case where the added function list is the added function list 501 illustrated in FIG. 5 and the PT is the PT 603 illustrated in FIG. 6B. In the PT 603, since the Option PagesPerSheet_2 of the JobNUpAllDocumentsContiguously function is designated, determination in step S1002 is YES (YES in step S1002), and the processing proceeds to step S1003.

In step S1003, the print data editing unit 208 edits drawing data included in the print data received from the OS. The Option PagesPerSheet_2 of the JobNUpAllDocumentsContiguously function that is designated in the PT 603 means N-Up printing with the number of pages per sheet being two. Since the function is a function added by the extension application 204, even if the function is designated, the print data generation software 202 does not execute processing necessary for implementing the function. Nevertheless, in the present exemplary embodiment, an Option indicating a pseudo resolution is designated in the PT in the processing in step S803. The print data generation software 202 is configured to properly refer to the resolution in the PT and generate print data in a size suitable for the resolution. Thus, drawing data included in the print data generated by the print data generation software 202 becomes data not reflecting the N-Up print function with the number of pages per sheet being two, but data reflecting reduction processing of each page that is to be required for N-Up printing with the number of pages per sheet being two.

Thus, in the processing in step S1003, the print data editing unit 208 can generate drawing data reflecting the N-Up print function with the number of pages per sheet being two, as illustrated in FIG. 7B, by arranging the reduced drawing data corresponding to two pages in one page. Since drawing data corresponding to each page has already been reduced into an appropriate size, the print data editing unit 208 does not perform the reduction processing of drawing data. In a case where each piece of drawing data is smaller than the region 704, the print data editing unit 208 arranges the drawing data at the center of the region 704. Alternatively, the print data editing unit 208 may match an upper left corner of the drawing data with an upper left corner of the region 704. As the width of a blank region between pages, the same value as the width n used in the calculation processing in step S803 is used.

By the above-described processing, the print data editing unit 208 converts drawing data into A4-sized drawing data at 600 dpi that reflects the N-Up print function with the number of pages per sheet being two, by arranging, side by side, two pieces of A4-sized drawing data created at 400 dpi, for example. In this example, the number of pages per sheet has been described as two, but equivalent processing can be applied to another number of pages per sheet.

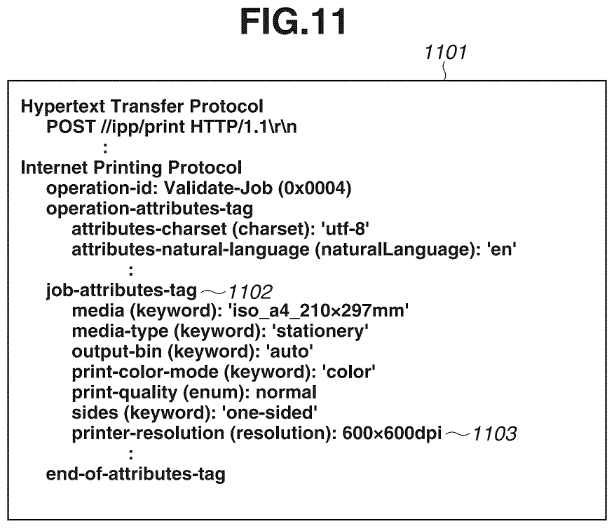

Next, in step S1004, the print data editing unit 208 changes print setting attribute information in the print data based on the setting change list. FIG. 11 conceptually illustrates an example of a Validate-Job operation in the IPP. A Validate-Job operation 1101 is data indicating an operation issued at the beginning of print data conforming to the IPP. The Validate-Job operation 1101 includes a job-attributes-tag indicating print setting attribute information 1102. The print setting attribute information 1102 includes attribute information indicating a sheet size and resolution information, and the printing apparatus 102 performs printing conforming to the attribute information.

According to the setting change list 901 illustrated in FIG. 9, the resolution has been changed from 600 dpi to 400 dpi. Based on the resolution of 400 dpi designated in the PT in the processing in step S803, the print data generation software 202 generates drawing data at 400 dpi, and designates 400 dpi in print setting attribute information. Nevertheless, the resolution of 400 dpi is a pseudo resolution added by the extension application 204, and the printing apparatus 102 cannot execute printing based on the resolution. Accordingly, the print data editing unit 208 changes the resolution included in the print setting attribute information 1102 to 600×600 dpi in accordance with the setting change list 901. Information 1103 indicates an example of the change.

By the above-described processing, the print data at 400 dpi that does not include an N-Up setting and has been generated by the print data generation software 202 is converted into the print data at 600 dpi in which the N-Up print function with the number of pages per sheet being two is set. Thus, if the printing apparatus 102 prints the print data, a result of N-Up printing with the number of pages per sheet being two is obtained.

As described above, in the printing system according to the present exemplary embodiment, the print function can be extended by the extension application 204. In addition, a function requiring editing involving enlargement or reduction of drawing data can be added. Since the drawing data included in the intermediate data is vector data, characters do not deteriorate even if the drawing data is enlarged or reduced. Nevertheless, since the drawing data included in the print data generated by the print data generation software 202 based on the intermediate data is raster data, deterioration is caused by enlargement or reduction. Particularly in the case of reduction, a specific line may be thinned out, and thus visibility of small characters drastically deteriorates. In the printing system according to the present exemplary embodiment, enlargement or reduction that is to be required in an extended function is executed by the print data generation software 202 by using the pseudo resolution. Since the print data generation software 202 performs processing of generating the print data being raster data from the intermediate data being the vector data, the raster data without deterioration that suits the resolution set at the time of generation is generated. The print data editing unit 208 implements the extended function by editing the raster data generated in this manner, without enlarging or reducing the data again. With this configuration, the printing system according to the present exemplary embodiment can add a function requiring editing involving enlargement or reduction, without causing image quality deterioration.

In the present exemplary embodiment, an example of the N-Up print function with the number of pages per sheet being two has been described. Needless to say, the present exemplary embodiment is also applicable to the number of pages per sheet that is other than two. In addition, the present exemplary embodiment with an equivalent configuration is also applicable to a function other than the N-Up print function, such as a function of reduced printing, for example, and is also applicable to a function involving enlargement instead of reduction. Furthermore, two or more different functions may be extended. In this case, in step S803, the print setting editing unit 206 desirably designates a pseudo resolution considering an enlargement/reduction ratio to be required when the two or more different functions are used in combination. Furthermore, in step S1003, the print data editing unit 208 desirably executes editing to be required in the two or more different functions.

### Second Exemplary Embodiment

Next, a second exemplary embodiment will be described. In the present exemplary embodiment, the extension application 204 adds a booklet print function. The booklet print function is a function of executing printing while rearranging pages so that a printed result of the printing apparatus 102 can be read as a booklet by folding the printed result at the center. The components and processing which are not mentioned in the following description are equivalent to those of the first exemplary embodiment, and thus descriptions thereof are omitted.

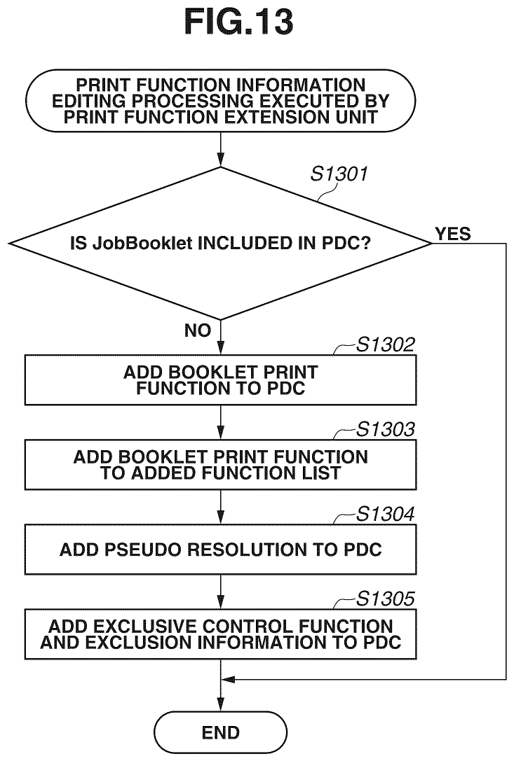

FIG. 13 is a diagram illustrating a major processing procedure of print function information editing processing to be executed by the print function extension unit 207 in the printing system according to the present exemplary embodiment. In the following description, each piece of processing will be described as being executed by the print function extension unit 207 in some cases. Actually, a corresponding function is implemented by the CPU 111 executing a corresponding program.

Because the processing in steps S1301 to S1305 of FIG. 13 is processing executed for the purpose equivalent to that of the processing in steps S301 to S305 of FIG. 3 except for points mentions below, the description of common processing will be omitted.

As a first difference, in the present exemplary embodiment, in step S1302, the print function extension unit 207 adds the booklet print function in place of the N-Up print function. Thus, a Feature name added to PDC becomes JobBooklet, not JobNUpAllDocumentsContiguously.

As a second difference, because the booklet print function only involves reduction required for N-Up printing with the number of pages per sheet being two, in step S1304, small pseudo resolutions such as 100 dpi and 200 dpi are not added. In the procedure illustrated in FIG. 13, the print function extension unit 207 is configured to extend only the booklet print function, but may be configured to also extend the N-Up print function. In this case, the print function extension unit 207 also executes the processing in steps S301 to S305 of FIG. 3. More specifically, in a case where it is determined that the OS and the print data generation software 202 do not support the N-Up print function, the print function extension unit 207 adds the N-Up print function to an added function list and also edits the PDC appropriately.

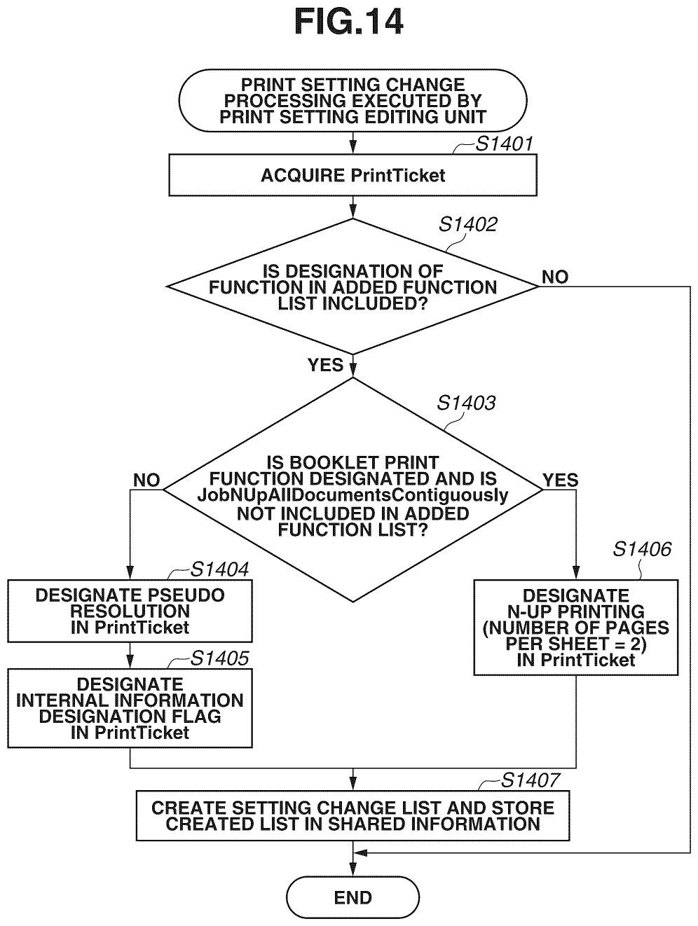

FIG. 14 is a diagram illustrating a major processing procedure of print setting change processing to be executed by the print setting editing unit 206 in the printing system. In the following description, each piece of processing will be described as being executed by the print setting editing unit 206 in some cases. Actually, a corresponding function is implemented by the CPU 111 executing a corresponding program.

The processing in FIG. 14 excluding steps S1403 and S1406 is processing executed for the booklet print function for the purpose equivalent to that of the processing in steps S801 to S805 of FIG. 8. Thus, the description of common processing will be omitted.

In step S1402, the print setting editing unit 206 determines whether the booklet print function or the N-Up print function is designated in the PT.

In step S1403, the print setting editing unit 206 determines whether the booklet print function is designated in the PT and JobNUpAllDocumentsContiguously is not included in the added function list. In this example, the print function extension unit 207 also executes the processing in steps S301 to S305 of FIG. 3 as described above. In a case where determination in step S1403 is YES, this means that the booklet print function is designated using the print setting screen extension unit 205 and the N-Up print function is not added to the added function list by the print function extension unit 207 (i.e., the N-Up print function is supported by the OS and the print data generation software 202). On the other hand, in a case where the determination is NO in step S1403, there are two cases. The first case is a case where an extended function other than the booklet print function (i.e., N-Up print function) is designated using the print setting screen extension unit 205. The second case is a case where the booklet print function is designated using the print setting screen extension unit 205, and the N-Up print function is added to the added function list by the print function extension unit 207 (i.e., the N-Up print function is unsupported by the OS and the print data generation software 202).

In the case where the determination is YES in step S1403, the processing proceeds to step S1406. In step S1406, the print setting editing unit 206 designates N-Up printing with the number of pages per sheet being two, in the PT. The N-Up printing with the number of pages per sheet being two is equivalent to booklet printing in reduction of pages although the order of the pages is different. In the present exemplary embodiment, utilizing this point, the print setting editing unit 206 uses not a pseudo resolution but the N-Up print function to implement reduction.

In a case where the print setting editing unit 206 executes the processing in step S1406, the print data generation software 202 generates print data edited for the N-Up print function with the number of pages per sheet being two. Because the extension application 204 has not changed the resolution, the resolution remains to be the resolution designated by the printing apparatus 102.

In a case where determination in step S1402 is NO, while the booklet print function or the N-Up print function is designated, the N-Up print function is unsupported by the OS and the print data generation software 202. In this case, the print setting editing unit 206 executes reduction required for the booklet printing or the N-Up printing using a pseudo resolution in a similar manner as that described in the first exemplary embodiment.

Then, the print data editing unit 208 executes processing of editing the print data generated by the print data generation software 202. This processing procedure is illustrated in FIG. 10 as in the first exemplary embodiment.

Since the processing in steps S1001 and S1002 is as described in the first exemplary embodiment, the detailed description will be omitted. In step S1002, the print data editing unit 208 determines whether the booklet print function or the N-Up print function is designated in the PT.

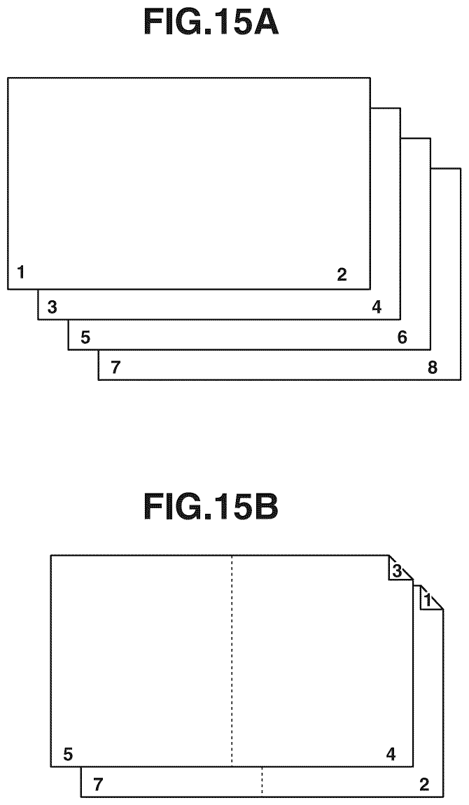

In a case where the determination in step S1403 is YES, in step S1003, the print data editing unit 208 edits the drawing data as follows. The editing will be described with reference to FIGS. 15A and 15B. FIG. 15A is a schematic diagram illustrating the drawing data included in the print data generated by the print data generation software 202. As illustrated in FIG. 15A, Page 1 and Page 2 are arranged on one sheet, and subsequently, each pair of two consecutive pages generated by the drawing application 201 are similarly arranged on one sheet. FIG. 15B illustrates an example of the drawing data edited in the processing in step S1003. In the booklet printing, pages are arranged as illustrated in FIG. 15B so that a printed product being a printed result becomes a booklet when the printed product is folded at the center. The print data editing unit 208 converts the drawing data corresponding to the pages illustrated in FIG. 15A into data as illustrated in FIG. 15B by rearranging (i.e., moving) the pages without enlarging or reducing the drawing data. In a case where the determination in step S1403 is NO, in step S1003, the print data editing unit 208 performs editing equivalent to that in the first exemplary embodiment. Furthermore, in a case where the booklet print function is designated, the print data editing unit 208 also performs the above-described rearrangement (movement) processing in addition to the editing equivalent to that in the first exemplary embodiment.

Lastly, in step S1004, the print data editing unit 208 changes print setting attribute information included in the print data. In the case where the processing in step S1406 is executed, because the resolution remains to be the resolution designated by the printing apparatus 102, as described above, there is no need to change the resolution. In this example, in a case where the booklet print function is designated and a duplex printing setting is not designated, the print data editing unit 208 performs processing of designating the duplex printing setting in print setting attribute information. The duplex printing setting may be forcibly enabled in the case where the booklet print function is designated using the print setting screen extension unit 205 or the print setting editing unit 206.

The extension application 204 according to the present exemplary embodiment uses not a pseudo resolution but the N-Up print function to execute enlargement or reduction to be required in the booklet print function as a function to be extended. In a case where the pseudo resolution is used, data can be sometimes reduced to a size smaller than an expected size. Nevertheless, in a case where the N-Up print function is used, data is always reduced to an expected size. In this manner, to cause the print data generation software 202 to execute enlargement/reduction processing, it is sufficient that a function that is supported by the print data generation software 202 and that involves enlargement or reduction is used, and the function to be used is not limited to the pseudo resolution and the N-Up print function.

### Third Exemplary Embodiment

Next, a third exemplary embodiment will be described. In the present exemplary embodiment, in a case where a predetermined condition is unsatisfied, processing for skipping the processing to be executed by the print data generation software 202 is performed. The components and processing which are not mentioned in the following description are equivalent to those of the first exemplary embodiment, and thus the descriptions thereof are omitted.

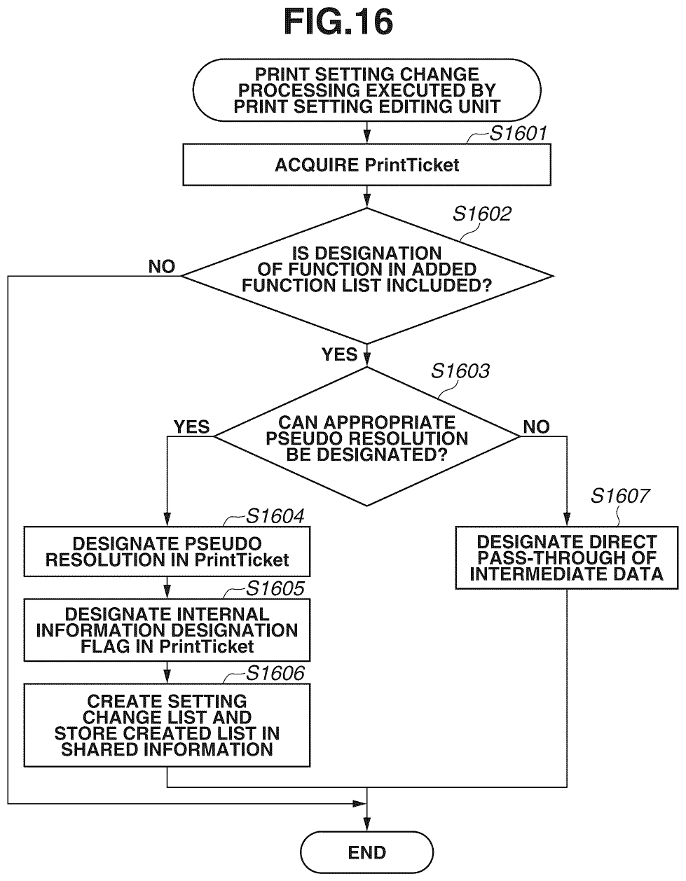

FIG. 16 is a diagram illustrating a major processing procedure of print function information editing processing to be executed by the print setting editing unit 206 in the printing system according to the present exemplary embodiment. In the following description, each piece of processing will be described as being executed by the print setting editing unit 206 in some cases. Actually, a corresponding function is implemented by the CPU 111 executing a corresponding program.

Because the processing in FIG. 16 excluding steps S1603 and S1607 is processing executed for the purpose equivalent to that of the processing in steps S801 to S805 of FIG. 8, the description thereof will be omitted.

In step S1603, the print setting editing unit 206 determines whether a pseudo resolution appropriate for executing the designated function can be designated. For example, in a case where 480 dpi is calculated as an appropriate pseudo resolution by the method used in step S803 of the first exemplary embodiment, if 500 dpi is designated, print data becomes larger than expected data, and drawing data becomes partly deficient. On the other hand, if 400 dpi is designated, the drawing data becomes too small. In such a case, the print setting editing unit 206 determines step S1603 as NO.

In step S1607, the print setting editing unit 206 instructs the OS to directly pass through intermediate data. As a premise, in the present exemplary embodiment, the print setting editing unit 206 can instruct the OS to deliver the intermediate data to the print data editing unit 208 without passing through the print data generation software 202. In step S1607, the print setting editing unit 206 issues such an instruction, and ends the processing of this procedure. In a case where it is determined in step S1602 that a specific function is designated, the processing in step S1607 may always be executed without performing the determination in step S1603.

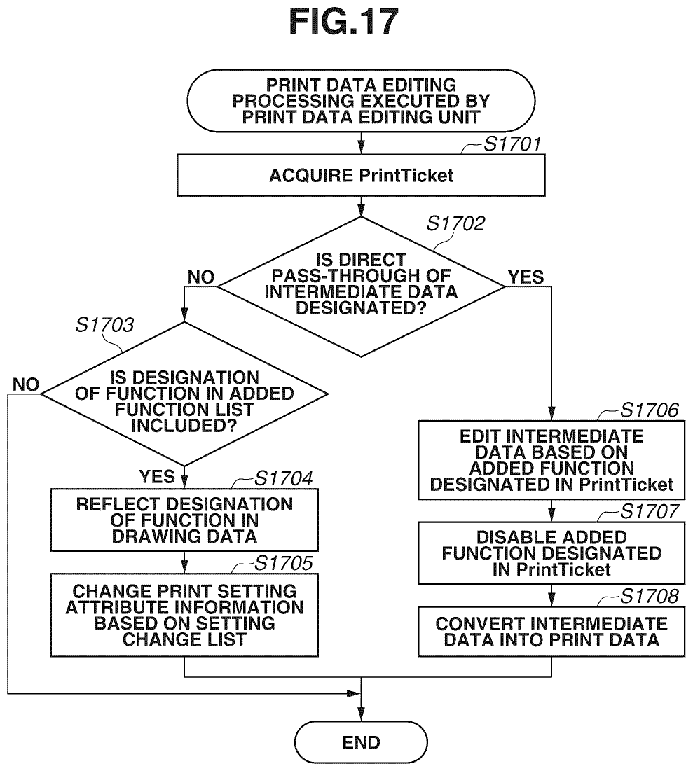

FIG. 17 is a diagram illustrating a major processing procedure of print data editing processing to be executed by the print data editing unit 208 according to the present exemplary embodiment. In the following description, each piece of processing will be described as being executed by the print data editing unit 208 in some cases. Actually, a corresponding function is implemented by the CPU 111 executing a corresponding program.

Because the processing in FIG. 17 excluding steps S1702, S1706, S1707, and S1708 is processing executed for the purpose equivalent to that of the processing in steps S1001 to S1004 of FIG. 10, the description thereof will be omitted.

In step S1702, the print data editing unit 208 determines whether the print setting editing unit 206 has designated direct pass-through of the intermediate data without passing through the print data generation software 202. In a case where the print setting editing unit 206 has executed the processing in step S1607, the determination in step S1702 is YES.

In step S1706, the print data editing unit 208 edits the intermediate data based on the added function designated in the PT. Because the intermediate data is vector data, even if the editing involves enlargement or reduction, characters do not deteriorate.

Next, in step S1707, the print data editing unit 208 disables the added function designated in the PT included in the intermediate data. The processing is performed to prevent editing processing for the added function from being executed again when the intermediate data is converted into the print data in the processing to be described below.

Lastly, in step S1708, the print data editing unit 208 converts the intermediate data into the print data. The conversion processing into the print data may be executed by the print data editing unit 208, or may be executed by instructing the print data generation software 202 to process the edited intermediate data again. In other words, the print data editing unit 208 may instruct the print data generation software 202 to execute the conversion processing from the intermediate data into the print data. In the latter case, although it is necessary for the OS to support such a function, the conversion processing from the intermediate data into the print data is centralized to the print data generation software 202. Thus, a stable conversion result can be always obtained irrespective of settings.

In the printing system according to the present exemplary embodiment, in a case where an extended function involving enlargement or reduction is designated, direct pass-through of the intermediate data is designated, and the intermediate data is edited, whereby deterioration caused by the enlargement or reduction is prevented. In a case where the enlargement or reduction is not required, the intermediate data is not directly passed through. Thus, the print data editing unit 208 executes special processing only for a specific function, and allows most processing to be executed by the print data generation software 202.

The present invention is not limited to the above-described exemplary embodiments, and various changes and modifications can be made without departing from the spirit and scope of the present invention. Thus, the following claims are appended for publishing the scope of the present invention.

According to an aspect of the present invention, it is possible to provide a better function as an extension application.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A non-transitory computer-readable storage medium storing an application program for supporting a software program for obtaining capability information of a printer according to an Internet Print Protocol, the application program including instructions, which when executed by one or more processors of an information processing apparatus, cause the information processing apparatus to perform operations comprising:
causing, by executing the application program, a display of the information processing apparatus to display a print setting screen for receiving a print setting;
controlling, based on the print setting by executing the application program, the software program not to convert vector data to raster data; and
editing, by executing the application program, the vector data which is not converted to the raster data by the software program

2. The non-transitory computer-readable storage medium according to claim 1, wherein, if the print setting is a predetermined setting, the software program is controlled not to convert the vector data to the raster data.

3. The non-transitory computer-readable storage medium according to claim 2, wherein the predetermined setting is a print setting requiring editing involving enlargement of the vector data.

4. The non-transitory computer-readable storage medium according to claim 2, wherein the predetermined setting is a print setting requiring editing involving reduction of the vector data.

5. The non-transitory computer-readable storage medium according to claim 2, wherein the predetermined setting is a print setting regarding an N-Up print function.

6. The non-transitory computer-readable storage medium according to claim 1, wherein the software program is controlled based on the print setting not to convert the vector data to the raster data by instructing the software program to deliver the vector data to the application program without passing through the software program.

7. The non-transitory computer-readable storage medium according to claim 1, wherein the software program is an IPP class driver.

8. The non-transitory computer-readable storage medium according to claim 1, wherein the software program is included in an operating system.

9. A control method for supporting, by an application program, a software program for obtaining capability information of a printer according to an Internet Print Protocol, the control method comprising:
causing, by executing the application program, a display of an information processing apparatus to display a print setting screen for receiving a print setting;
controlling, based on the print setting by executing the application program, the software program not to convert vector data to raster data; and
editing, by executing the application program, the vector data which is not converted to the raster data by the software program.

10. An information processing apparatus having an application program for supporting a software program for obtaining capability information of a printer according to an Internet Print Protocol, the information processing apparatus comprising:
a display; and
a controller that causes, by executing the application program, a display of an information processing apparatus to display a print setting screen for receiving a print setting,
wherein the controller controls, based on the print setting by executing the application program, the software program not to convert vector data to raster data, and
wherein the controller edits, by executing the application program, the vector data which is not converted to the raster data by the software program.
